(19) United States
(12) Patent Application Publication
(10) Pub. No.: US 2022/0281446 A1
(43) Pub. Date: Sep. 8, 2022

(54) CONTROL DEVICE, MOBILE OBJECT, CONTROL METHOD, AND COMPUTER-READABLE STORAGE MEDIUM

(71) Applicant: HONDA MOTOR CO.,LTD., Tokyo (JP)

(72) Inventors: Suguru YOSHIDA, Tokyo (JP); Yusuke OI, Tokyo (JP)

(21) Appl. No.: 17/673,796

(22) Filed: Feb. 17, 2022

(30) Foreign Application Priority Data
Mar. 3, 2021 (JP) 2021-033974

(51) Int. Cl. B60W 30/095; B60W 30/09; B60W 40/105; B60W 40/114; B60W 50/14; G06V 20/58; H04W 4/40; H04W 4/90

(52) U.S. Cl. CPC B60W 30/0956; B60W 30/09; B60W 40/105; B60W 40/114; B60W 50/14; G06V 20/58; H04W 4/40; H04W 4/90; B60W 2050/146; B60W 2520/105; B60W 2520/14; B60W 2554/4029; B60W 2554/4041; B60W 2554/4044; B60W 2554/802; B60W 2554/804; B60W 2556/45

(57) ABSTRACT

A control device comprises: a first identification unit for identifying a position of a target located ahead of an advancing direction of a mobile object; a time calculating unit for calculating time for the object to reach the target position; a second identification unit for identifying the target position in a direction intersecting the advancing direction from an image captured by an image capturing unit installed in the object; a determination unit for determining whether a difference between a position of the object and the target position in the intersecting direction is within a predetermined range when the calculated time has become shorter than a predetermined threshold and it is determined the object position in the advancing direction has reached the position identified by the first identification unit; and a report control unit for performing report control when the determination unit determines the difference is within the range.

The contents of the following Japanese patent application(s) are incorporated herein by reference: NO. 2021-033974 filed on Mar. 3, 2021.

### BACKGROUND

### 1. Technical Field

The present invention relates to a control device, a mobile object, a control method, and a computer-readable storage medium.

### 2. Related Art

Patent Document 1 describes judging that a target object has collided with a subject vehicle when time at which an acceleration sensed by an acceleration sensor for protecting occupants from front collision, which senses front collision to actuate an airbag or the like, exceeds a threshold is within collision prediction allowable time, and notifying a center of the collision.

Patent Document 1: Japanese Patent Application Publication No. 2020-169016

### BRIEF DESCRIPTION OF THE DRAWINGS

FIG. 1 schematically illustrates a usage scene of a report system 10 according to an embodiment.

FIG. 2 illustrates a system configuration of a vehicle 20.

FIG. 3 is a diagram for schematically describing an example of a process flow implemented by a control device 40.

FIG. 4 is a diagram for describing a process when the vehicle 20 is approaching a pedestrian 80.

FIG. 5 illustrates an execution procedure of a control method executed by the control device 40.

FIG. 6 illustrates an exemplary computer 2000 in which some embodiments of the present invention may be wholly or partially embodied.

### DESCRIPTION OF EXEMPLARY EMBODIMENTS

While the present invention will be described below by means of embodiments of the invention, these embodiments below are not intended to limit the invention defined by the claims. In addition, all combinations of features set forth in the embodiments are not necessarily essential to the solutions of the present invention.

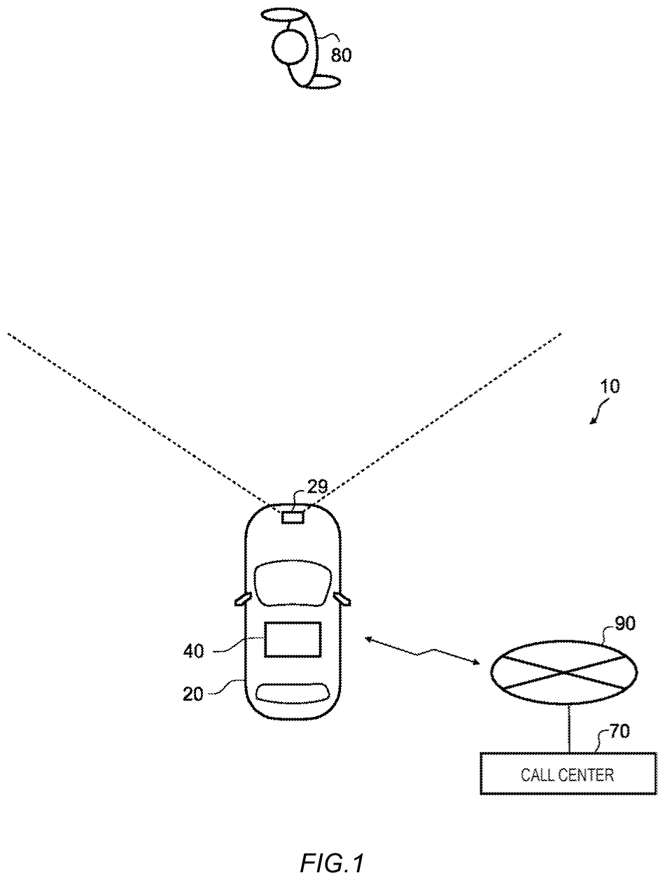

FIG. 1 schematically illustrates a usage scene of a report system 10 according to an embodiment. The report system 10 comprises a vehicle 20 and a call center 70. The vehicle 20 is an example of a “mobile object”. A pedestrian 80 is an example of a “target” to be recognized by the vehicle 20.

For the report system 10, the vehicle 20 comprises a sensor 29 and a control device 40. The sensor 29 comprises a camera for capturing images of the front of the vehicle 20, and a yaw rate sensor, for example. Here, the camera or the yaw rate sensor may be provided separately on different positions of the vehicle 20. For example, the sensor 29 is located at the edge of the vehicle 20 in FIG. 1 but not limited thereto, and it may be located on a position where images of the front of the vehicle 20 can be captured, including the top of a wind shield, a ridge of a roof, or on the roof. Images captured by the camera provided in the sensor 29 are acquired continuously, and the pedestrian 80 is recognized from the acquired images. As the control device 40 proceeds, a distance between the pedestrian 80 and the vehicle 20 is decreased. Whereby, a figure of the pedestrian 80 in the image comprised by the sensor 29 also becomes larger. The control device 40 calculates, based on a change in the size of the figure of the pedestrian 80 and a vehicle speed of the vehicle 20, time taken by the vehicle 20 to reach the position of the pedestrian 80.

When the time taken by the vehicle 20 to reach the position of the pedestrian 80 has become shorter than a predetermined threshold, the control device 40 calculates the position of the pedestrian 80 in the direction intersecting an advancing direction of the vehicle 20 from the images acquired continuously by the camera comprised in the sensor 29. Moreover, the control device 40 calculates a position in the direction intersecting the advancing direction of the vehicle 20 based on information acquired from the yaw rate sensor. Note that the direction intersecting the advancing direction of the vehicle 20 is a direction, for example, that is perpendicular to the advancing direction of the vehicle 20 and substantially parallel to a traveling surface of a road. Note that, in order to clarify the explanation, the direction intersecting the advancing direction of the vehicle 20 may be referred to as a “transverse direction,” while the advancing direction of the vehicle 20 may be referred to as a “longitudinal direction.

The control device 40 determines whether the position of the vehicle 20 in the transverse direction overlaps the transverse position of the pedestrian 80 if it is judged that the position of the vehicle 20 in the longitudinal direction overlaps the position of the pedestrian 80. When determining that the transverse position of the vehicle 20 overlaps the transverse position of the pedestrian 80, the control device 40 report it to the call center 70 over a network 90. Whereby, using the information acquired from the camera or the yaw rate sensor comprised in the sensor 29, whether to report to the call center 70 can be determined appropriately without relying on an acceleration sensor for protecting occupants from front collision.

For example, when a method is adopted that determines whether to report to the call center based on a magnitude of acceleration detected by the acceleration sensor for protecting occupants from front collision, report to the call center may not be made due to a failure of sensing a contact of a vehicle traveling at low speed with an object. Conversely, an unnecessary report to the call center may be made if a large magnitude of acceleration is detected when traveling on a rough road.

For this case, using the information acquired from the camera or the yaw rate sensor comprised in the sensor 29, the control device 40 can determine appropriately whether to report to the call center 70 by taking into account the respective positions of the vehicle 20 and the pedestrian 80 in the transverse direction. As such, when it is determined that the positions of the vehicle 20 and the pedestrian 80 overlap in the transverse direction, for example, a report to the call center 70 can be made, thus allowing enhancement of the safety. Moreover, it can avoid making an unnecessary report to the call center 70 when it is determined that the positions of the vehicle 20 and the pedestrian 80 had not overlapped in the transverse direction.

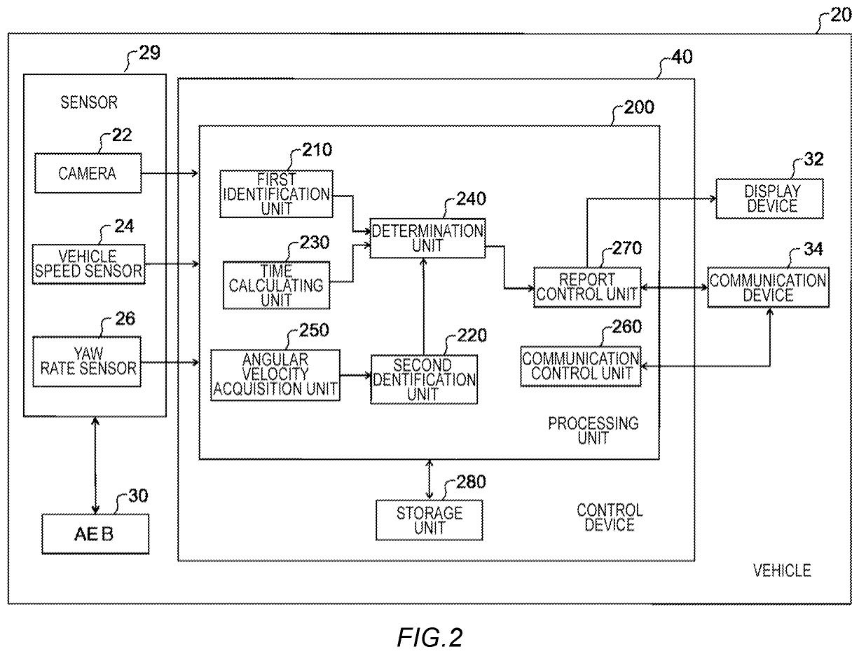

FIG. 2 illustrates a system configuration of the vehicle 20. The vehicle 20 comprises the sensor 29, a display device 32, a communication device 34, and an AEB 30.

A communication device 34 performs communication with the call center 70 over the network 90. The display device 32 performs report to an occupant of the vehicle 20. The display device 32 may include equipment that is responsible for a display function of an HMI (Human Machine Interface), an IVI (in-vehicle infotainment), and an MID (Multi Information Display).

The sensor 29 comprises a camera 22, a vehicle speed sensor 24, and a yaw rate sensor 26. The camera 22 is an example of an image capturing unit that captures images in the advancing direction of the vehicle 20 to generate image information. The vehicle speed sensor 24 is mounted to a transmission or the like and generates information that indicates a vehicle speed of the vehicle 20. The yaw rate sensor 26 generates information that indicates a yaw rate of the vehicle 20.

The AEB 30 is an Autonomous Emergency Braking system. The AEB 30 performs automatic braking based on the information detected by the sensor 29.

The control device 40 comprises a processing unit 200 and a storage unit 280. The processing unit 200 is implemented by a computational processing device including a processor, for example. The storage unit 280 is implemented by comprising a non-volatile storage medium. The processing unit 200 performs processing using information stored in the storage unit 280. The processing unit 200 may be implemented by an ECU (Electronic Control Unit) that comprises a microcomputer comprising a CPU, a ROM, a RAM, an I/O, a bus and the like.

The processing unit 200 comprises a first identification unit 210, a time calculating unit 230, a determination unit 240, an angular velocity acquisition unit 250, a second identification unit 220, and a report control unit 270.

The first identification unit 210 identifies a position of a target located ahead of the advancing direction of the vehicle 20. The time calculating unit 230 calculates time taken by the vehicle 20 to reach the position of the target identified by the first identification unit 210. The second identification unit 220 identifies the position of the target in the direction intersecting the advancing direction from the images captured by the camera 22. The determination unit 240 determines whether a difference between the position of the vehicle 20 and the position of the target in the direction intersecting the advancing direction is within a predetermined range when the time calculated by the time calculating unit 230 has become shorter than a predetermined threshold and it is determined that the position of the vehicle 20 in the advancing direction has reached the position identified by the first identification unit 210. The report control unit 270 performs report control when the determination unit 240 determines that the difference between the position of the vehicle 20 and the position of the target in the direction intersecting the advancing direction is within the predetermined range.

The report control unit 270 performs the report control when the determination unit 240 determines that the difference between the position of the vehicle 20 and the position of the target in the direction intersecting the advancing direction is within the predetermined range and the time taken by the vehicle 20 to reach the position of the target identified by the first identification unit 210 is shorter than the predetermined threshold.

The time calculating unit 230 may calculate the time taken by the vehicle 20 to reach the position of the target based on a temporal rate of change in the size of the figure of the target extracted from the image captured by the image capturing unit. The angular velocity acquisition unit 250 acquires angular velocity information of the vehicle 20 from a sensor that is installed in the vehicle 20 and detects a rotational movement of the vehicle 20. The angular velocity acquisition unit 250 acquires the angular velocity information of the vehicle 20 based on the information acquired from the yaw rate sensor 26. The second identification unit 220 calculates the position of the vehicle 20 in the direction intersecting the advancing direction based on the angular velocity information of the vehicle 20 and velocity information in the advancing direction of the vehicle 20.

A communication control unit 260 controls reception of a position of a mobile terminal from the mobile terminal located at the position identified by the first identification unit 210. The communication control unit 260 controls reception of the position of the mobile terminal from the mobile terminal through the communication device 34. The determination unit 240 corrects the predetermined range based on the position of the mobile terminal received from the mobile terminal.

The report control unit 270 may control a call to the call center 70 that is available to take the call from the occupant of the vehicle 20. The report control unit 270 may report position information of the vehicle 20 to the call center 70. The report control unit 270 may perform the report control when the vehicle stops.

The report control unit 270 may perform the report control even when an airbag installed in the vehicle 20 is not deployed. After the AEB 30 installed in the vehicle 20 begins to operate as well, the first identification unit 210, the time calculating unit 230, and the second identification unit 220 continue to operate, and the determination unit 240 may determine whether the difference between the position of the vehicle and the position of the target in the direction intersecting the advancing direction is within the predetermined range.

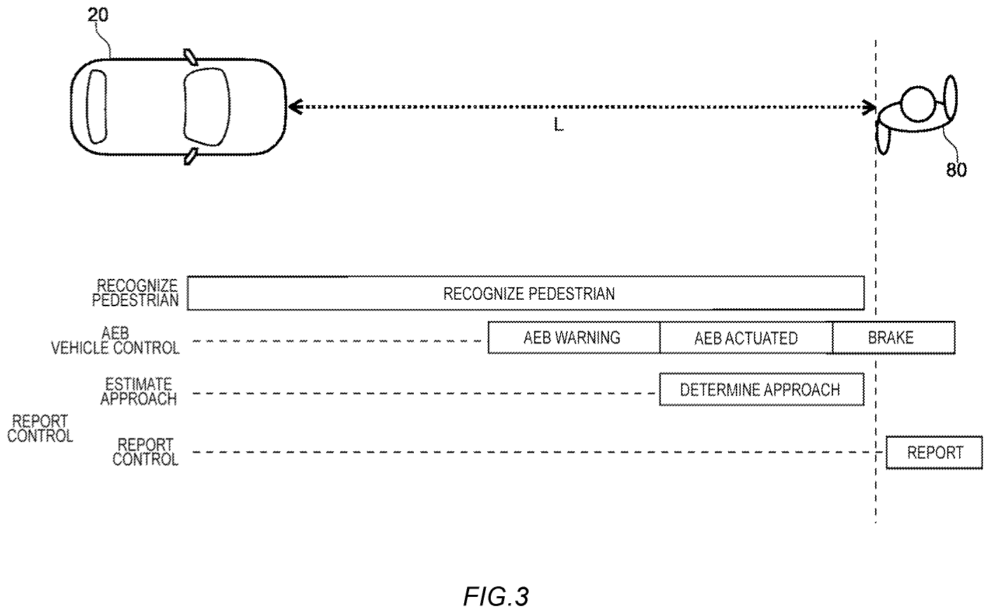

FIG. 3 is a diagram for schematically describing an example of a process flow implemented by the control device 40. The vehicle 20 performs continuously a process to recognize the target such as the pedestrian 80 by the sensor 29. The first identification unit 210 identifies a distance L from the vehicle 20 to the pedestrian 80. The time calculating unit 230 calculates time taken by the vehicle 20 to reach the position of the pedestrian 80.

Based on the information acquired from the sensor 29, the distance L from the vehicle 20 to the pedestrian 80, the vehicle speed of the vehicle 20, and the like, the AEB 30 performs warning to the occupant of the vehicle 20 when the vehicle 20 possibly approaches the pedestrian 80. Subsequently, the AEB 30 actuates an automatic brake when the vehicle 20 further approaches the pedestrian 80. Subsequently, the occupant manipulates a foot brake of the vehicle 20 and the vehicle 20 stops.

The determination unit 240 performs approach determination of the pedestrian 80 when the time taken by the vehicle 20 to reach the position of the pedestrian 80 has become shorter than the predetermined threshold and it is determined that the position of the vehicle 20 has reached the position of the pedestrian 80 in the longitudinal direction. Specifically, the second identification unit 220 identifies the position of the vehicle 20 in the transverse direction based on the information acquired from the yaw rate sensor 26. Moreover, the second identification unit 220 identifies the position of the pedestrian 80 in the transverse direction from the images captured continuously by the camera 22. The determination unit 240 identifies the position of the vehicle 20 in the transverse direction from the information acquired from the yaw rate sensor 26 and determines whether the position of the vehicle 20 in the transverse direction is within the predetermined range with respect to the position of the pedestrian 80 in the transverse direction. The report control unit 270 performs report to the call center through the communication device 34 when the position of the vehicle 20 in the transverse direction is within the predetermined range with respect to the position of the pedestrian 80 in the transverse direction. Moreover, the report control unit 270 may notify the occupant of the vehicle 20 through the display device 32 to perform report to the call center 70.

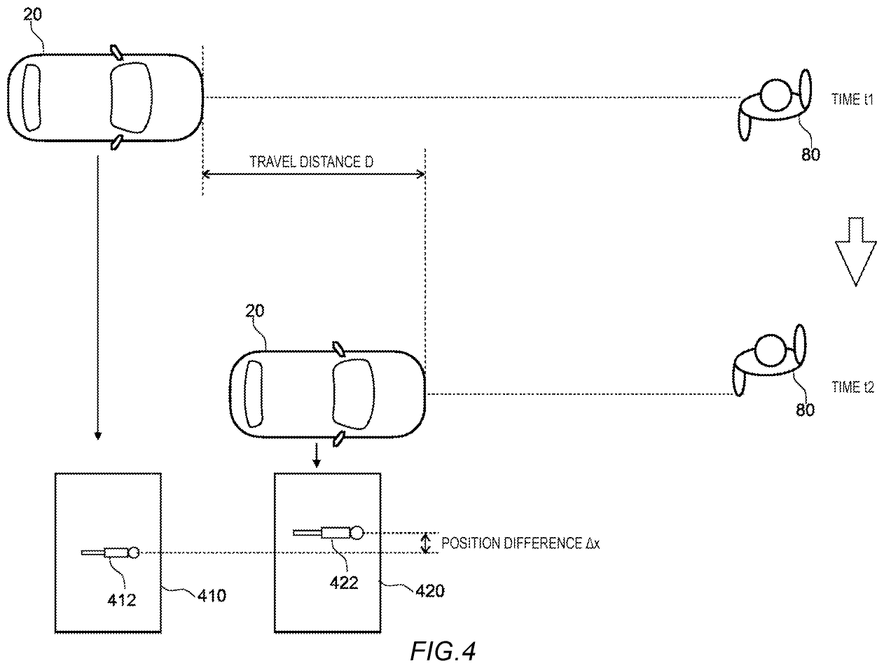

FIG. 4 is a diagram for describing a process when the vehicle 20 is approaching the pedestrian 80. At time t1, the time calculating unit 230 extracts a FIG. 412 of the pedestrian 80 from an image 410 captured by the camera 22 and identifies the size and position of the FIG. 412 in the image. At time t2 later than the time t1, it extracts a FIG. 422 of the pedestrian 80 from an image 420 captured by the camera 22 and identifies the size and position of the FIG. 422 in the image. The time calculating unit 230 identifies a travel distance D of the vehicle 20 in a period from the time t1 to the time t2 based on the vehicle speed acquired by the vehicle speed sensor 24. Based on a ratio of the size of the FIG. 422 to the size of the FIG. 412, the time is calculated taken by the vehicle 20 to reach the position of the pedestrian 80 in the longitudinal direction. Note that the time calculating unit 230 estimates a distance from the vehicle 20 to the pedestrian 80 based on the ratio of the size of the FIG. 422 to the size of the FIG. 412 and the travel distance D, and calculates the time taken by the vehicle 20 to reach the position of the pedestrian 80 in the longitudinal direction based on the distance from the vehicle 20 to the pedestrian 80 and the vehicle speed acquired by the vehicle speed sensor 24.

Moreover, the second identification unit 220 calculates a moving velocity of the pedestrian 80 in the transverse direction based on a position difference Δx between the position of the FIG. 412 and the position of the FIG. 422 in the images, and the time t2 and the time t1. The second identification unit 220 identifies the position of the pedestrian 80 in the transverse direction based on history of the moving velocity of the pedestrian 80. Note that the second identification unit 220 may calculate a relative moving velocity of the pedestrian 80 with respect to a moving velocity of the vehicle 20 in the transverse direction and calculate a relative position of the pedestrian 80 with respect to the position of the vehicle 20 in the transverse direction.

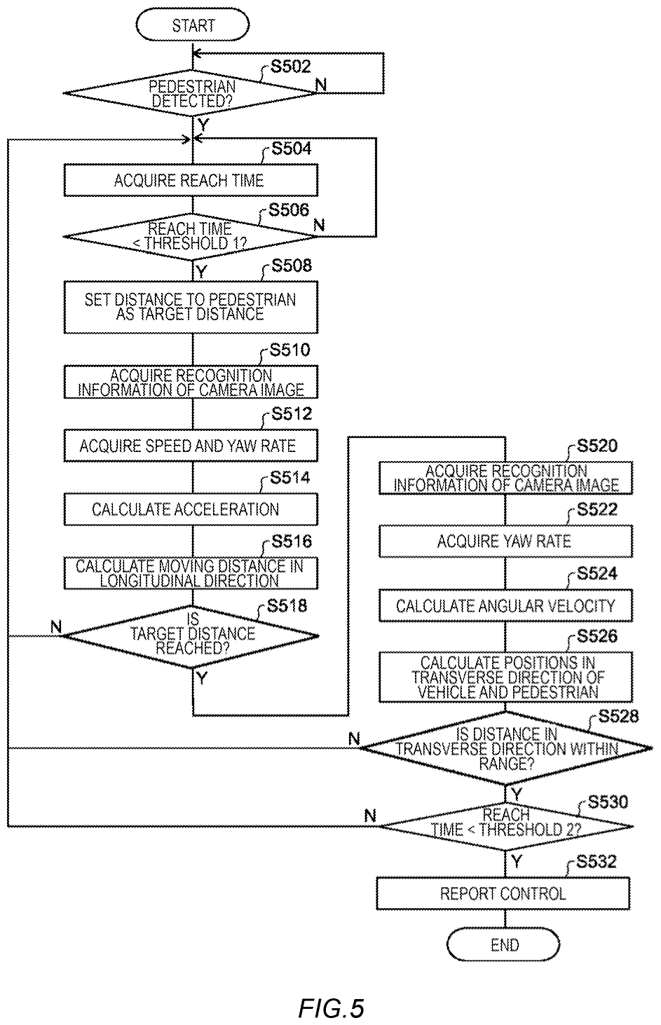

FIG. 5 illustrates an execution procedure of a control method executed by the control device 40. At S502, the time calculating unit 230 determines whether a pedestrian is detected from an image captured by the camera 22. If the pedestrian is not detected from the image, the determination at S502 is repeated. If the pedestrian is detected from the image captured by the camera 22, at S504, the time calculating unit 230 calculates a reach time that is time taken by the vehicle 20 to reach the position of the pedestrian 80. The time calculating unit 230, as described with reference to FIG. 4 and the like, may calculate the reach time using the images captured by the camera 22.

At S506, it is determined whether the reach time is shorter than a predetermined threshold 1. If the reach time is the predetermined threshold 1 or more, the process proceeds to S504. If the reach time is shorter than the predetermined threshold 1, at S508, the first identification unit 210 sets the distance to the pedestrian 80 detected at S502 as a target distance. At S510, the first identification unit 210 acquires information recognized from the images captured by the camera 22. The information acquired at S510 is such as a distance or reach time to the pedestrian 80. At S512, the first identification unit 210 acquires a vehicle speed and angular velocity information from the vehicle speed sensor 24 and the angular velocity acquisition unit 250. At S514, the first identification unit 210 calculates acceleration of the vehicle 20. At S516, the first identification unit 210 calculates a moving distance of the vehicle 20 in the longitudinal direction. The first identification unit 210 calculates the moving distance based on the vehicle speed of the vehicle 20 and the time. Note that the first identification unit 210 may correct the moving distance of the vehicle 20 in the longitudinal direction based on the angular velocity information. At S518, the first identification unit 210 determines whether the target distance set at S508 is reached. If the target distance is not reached, the process proceeds to S504. At S518, if it is determined that the target distance is reached, the process proceeds to S520.

At S520, the second identification unit 220 acquires information recognized from the images captured by the camera 22. The information acquired at S520 is a moving velocity and a position of the pedestrian 80 in the transverse direction. At S522, the second identification unit 220 acquires angular velocity information acquired by the angular velocity acquisition unit 250. At S524, the second identification unit 220 calculates an angular velocity of the vehicle 20. At S526, the second identification unit 220 calculates the positions of the vehicle 20 and the pedestrian 80 in the transverse direction. At S528, it is determined whether a difference between the positions of the vehicle 20 and the pedestrian 80 in the transverse direction calculated at S526 is within a predetermined range. If the difference between the positions of the vehicle 20 and the pedestrian 80 in the transverse direction is not within the predetermined range, the process proceeds to S504. If the difference between the positions of the vehicle 20 and the pedestrian 80 in the transverse direction is within the predetermined range, at S530, it is determined whether the reach time is shorter than a predetermined threshold 2. Note that the reach time may be information recognized from the images captured by the camera 22, for example. If the reach time is the predetermined threshold 2 or more, the process proceeds to S504. If the reach time is shorter than the predetermined threshold 2, at S532, the report control unit 270 performs report control. For example, the report control unit 270 performs report to the call center 70. Moreover, the report control unit 270 may present guidance information for performing report to the call center 70 to the occupant of the vehicle 20 through the display device 32.

Note that, when the pedestrian 80 carries a mobile terminal capable of mobile communications or near field communication, position information of the mobile terminal is acquired from the mobile terminal carried by the pedestrian 80 and the control above may be performed using the acquired position information of the mobile terminal. Communication between the communication device 34 and the mobile terminal may be performed by direct communication. The communication device 34 may communicate directly with the mobile terminal via Cellular-V2X communication. As direct communication between the communication device 34 and the mobile terminal, a form may be adopted that uses Wi-Fi (registered trademark), DSRC (registered trademark) (Dedicated Short Range Communications). As direct communication between the communication device 34 and the mobile terminal, any direct communication system may be adopted such as Bluetooth (registered trademark). The communication device 34 may communicate directly with the mobile terminal using a communication infrastructure comprised by ITS (Intelligent Transport Systems).

As an example, the communication control unit 260 acquires the position information of the mobile terminal from the mobile terminal located at the position identified by the first identification unit 210 through the communication device 34. For example, the communication control unit 260 transmits position request information containing the position identified by the first identification unit 210 through the communication device 34 via mobile communications or near field communication. Upon receiving the position request information from the communication device 34, the mobile terminal transmits a position request response containing the position of the mobile terminal to communication device 34 when a current position of the mobile terminal itself is within a predetermined range from the position contained in the position request information. Upon receiving a response from the mobile terminal, the first identification unit 210 may correct the position of the pedestrian 80 identified by the first identification unit 210 based on the position of the mobile terminal contained in the position request response. Moreover, the determination unit 240 may correct a breadth of a range used in the judgement at S528 based on the position of the mobile terminal contained in the response received from the mobile terminal. For example, the larger the difference is between the position of the mobile terminal contained in the position request response and the position identified by the first identification unit 210, the more the breadth of the range used in the judgement at S528 may be widened. Moreover, the breadth of the range used in the judgement at S528 may be widened when the position request responses are received from a plurality of mobile terminals. The report control unit 270 may correct the threshold 2 used in the judgement at S530 based on the position of the mobile terminal contained in the response received from the mobile terminal. For example, the larger the difference is between the position of the mobile terminal contained in the position request response and the position identified by the first identification unit 210, the larger the threshold 2 used in the judgement at S530 may be made. Moreover, the threshold 2 used in the judgement at S530 may be made larger when the position request responses are received from a plurality of mobile terminals. Moreover, the report control unit 270 may perform the report control when the position contained in the position request response acquired from the mobile terminal and the position of the vehicle 20 are within a predetermined range, even if the determination unit 240 determines that the difference between the position of the vehicle 20 and the position of the pedestrian 80 in the transverse direction is not within the predetermined range.

As described above, using the information acquired from the camera 22 or the yaw rate sensor 26 comprised in the sensor 29, the control device 40 can determine appropriately whether to report to the call center 70 by taking into account the respective positions of the vehicle 20 and the pedestrian 80 in the transverse direction. As such, when it is determined that the positions of the vehicle 20 and the pedestrian 80 overlap in the transverse direction, for example, a report to the call center 70 can be made, thus allowing enhancement of the safety. Moreover, it can avoid making an unnecessary report to the call center 70 when it is determined that the positions of the vehicle 20 and the pedestrian 80 do not overlap in the transverse direction.

Note that the vehicle 20 is a vehicle as an example of transportation equipment. The vehicle may be an automobile such as an automobile comprising an internal combustion engine, an electric vehicle, and a fuel cell vehicle (FCV). The automobile includes, e.g., a bus, a truck, and a two-wheeled vehicle. The vehicle may be a saddle type vehicle or the like, and may be a motorcycle. The transportation equipment may be any equipment for transporting people or items. The transportation equipment is an example of the mobile object. The mobile object is not limited to the transportation equipment but may be any movable equipment.

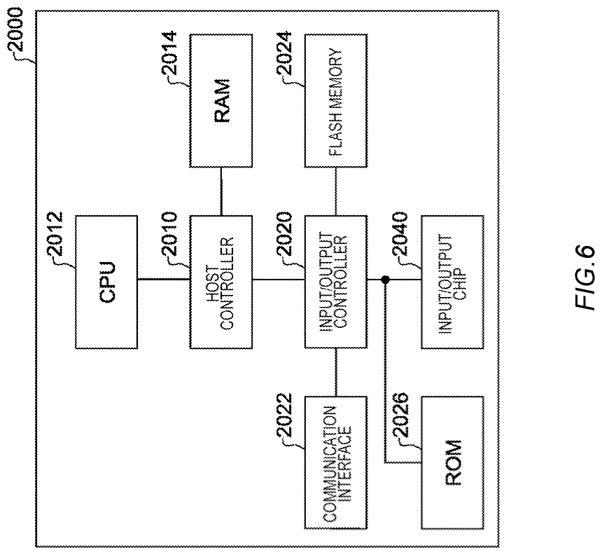

FIG. 6 illustrates an exemplary computer 2000 in which some embodiments of the present invention may be wholly or partially embodied. A program installed in the computer 2000 can cause the computer 2000 to function as an apparatus such as the control device 40 or each part the apparatus according to the embodiments, perform operations associated with the apparatus or each part of the apparatus, and/or perform a process or steps of the process according to the embodiments. Such a program may be executed by a CPU 2012 to cause the computer 2000 to perform specific operations associated with some or all of the blocks in the processing procedures and block diagrams described herein.

The computer 2000 according to the present embodiment includes the CPU 2012 and a RAM 2014, which are connected to each other via a host controller 2010. The computer 2000 also includes a ROM 2026, a flash memory 2024, a communication interface 2022, and an I/O chip 2040. The ROM 2026, the flash memory 2024, the communication interface 2022, and the I/O chip 2040 are connected to the host controller 2010 via an I/O controller 2020.

The CPU 2012 operates in accordance with a program stored in the ROM 2026 and the RAM 2014, thereby controlling each unit.

The communication interface 2022 communicates with other electronic devices via a network. The flash memory 2024 stores a program and data used by the CPU 2012 in the computer 2000. The ROM 2026 stores a boot program or the like executed by the computer 2000 upon activation, and/or a program dependent on hardware of the computer 2000. The I/O chip 2040 may also connect various I/O units, such as a keyboard, a mouse, and a monitor, to the I/O controller 2020 via I/O ports, such as a serial port, a parallel port, a keyboard port, a mouse port, a monitor port, an USB port, and an HDMI (registered trademark) port.

The program is provided via a computer-readable storage medium, such as a CD-ROM, a DVD-ROM, or a memory card, or via a network. The RAM 2014, the ROM 2026, or the flash memory 2024 are an example of the computer-readable storage medium. The program is installed in the flash memory 2024, the RAM 2014, or the ROM 2026, and executed by the CPU 2012. Information processing described in such a program is read by the computer 2000 to link the program with the various types of hardware resources as mentioned above. The apparatus or method may be configured by implementing the information operation or processing according to the use of the computer 2000.

For example, upon communication between the computer 2000 and an external device, the CPU 2012 may execute a communication program loaded in the RAM 2014 and, based on the processing described in the communication program, instruct the communication interface 2022 to perform communication processing. The communication interface 2022, under control of the CPU 2012, reads out transmission data stored in a transmission buffer processing area provided in a recording medium such as the RAM 2014 and the flash memory 2024, transmits the read-out transmission data to a network, and writes received data from the network in a reception buffer processing area or the like provided on the recording medium.

Moreover, the CPU 2012 may allow the RAM 2014 to read out all or necessary parts of a file or database stored in a recording medium such as the flash memory 2024, to perform various types of processing for the data stored on the RAM 2014. The CPU 2012 then writes back the processed data in the recording medium.

Various types of information such as various types of programs, data, tables, and databases may be stored in the recording medium for information processing. On the data read out from the RAM 2014, the CPU 2012 may perform various types of processing including various types of operations, information processing, condition determination, conditional branching, unconditional branching, and information retrieval/conversion, which are described herein and specified by an instruction sequence of a program, and writes back the result in the RAM 2014. The CPU 2012 may also retrieve information in a file or database in the recording medium. For example, when the recording medium stores a plurality of entries each having a first attribute value associated with a second attribute value, the CPU 2012 may retrieve an entry from the plurality of entries that satisfies a condition where the first attribute value is specified, read out the second attribute value stored in the entry, thereby acquiring the second attribute value associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet is usable as the computer-readable storage medium. The program stored in the computer-readable storage medium may be provided to the computer 2000 via the network.

The program installed in the computer 2000 and causes the computer 2000 to function as the control device 40 may operate on the CPU 2012 or the like to cause the computer 2000 to function respectively as each part of the control device 40. The information processing described in these programs are read in the computer 2000, thereby functioning as each part of the control device 40 which serves as specific means under cooperation of the software and the various types of hardware resources as described above. Thus, these specific means implement arithmetic operation or processing of information depending on a purpose of use of the computer 2000 in the present embodiment, thereby establishing the control device 40 specific to the purpose of use.

Various embodiments have been described with reference to the block diagrams or the like. In the block diagrams, each block may represent: (1) a step of a process for performing an operation; or (2) each part of an apparatus having a function to perform an operation. A specific step or each part may be implemented by a dedicated circuit, a programmable circuit provided along with computer-readable instructions stored on a computer-readable storage medium, and/or a processor provided along with computer-readable instructions stored on a computer-readable storage medium. The dedicated circuit may include a digital and/or analog hardware circuit, and may include an integrated circuit (IC) and/or a discrete circuit. The programmable circuit may include a reconfigurable hardware circuit, including, e.g., logic operations such as logic AND, logic OR, logic XOR, logic NAND, logic NOR, and the like, as well as memory elements such as a flip-flop, a register, a field programmable gate array (FPGA), a programmable logic array (PLA), and the like.

The computer-readable storage medium may include any tangible device that can store instructions to be performed by a suitable device, so that the computer-readable storage medium having the instructions stored therein constitutes at least a part of a product containing the instructions that can be executed to provide means for performing the operations specified in the processing procedures or block diagrams. Examples of the computer-readable storage medium may include an electronic storage medium, a magnetic storage medium, an optical storage medium, a magneto-electric storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically-erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

The computer-readable instructions may include assembler instructions, instruction set architecture (ISA) instructions, machine instructions, machine-dependent instructions, microcodes, firmware instructions, state setting data, or any of source codes or object codes described in any combination of one or more programming languages, including object-oriented programming languages, such as Smalltalk (registered trademark), JAVA (registered trademark), or C++, and conventional procedural programming languages, such as “C” programming languages or similar programming languages.

The computer-readable instructions are provided to processors or programmable circuits of general-purpose computers, special-purpose computers, or other programmable data processing apparatuses, locally or via a local area network (LAN) or a wide area network (WAN) such as the Internet, wherein the computer-readable instructions may be executed to provide means for performing the operations specified in the described processing procedures or block diagrams. Examples of the processors include a computer processor, a processing unit, a microprocessor, a digital signal processor, a controller, a microcontroller, and the like.

While the embodiments of the present invention have been described using the embodiments, the technical scope of the present invention is not limited to the scope described in the above embodiments. It is apparent to persons skilled in the art that various alterations or improvements can be added to the above embodiments. It is also apparent from the description of the claims that the embodiments added with such alterations or improvements can be included in the technical scope of the present invention.

It should be noted that each processing of the operations, procedures, steps, stages, and the like performed by the apparatus, system, program, and method illustrated in the claims, specification, and drawings can be implemented in any order unless the execution order is explicitly specified by terms “prior to,” “before,” or the like and unless the output from a previous process is used in a later process. Even if the operational flow is described using terms “first,” “next,” or the like in the claims, specification, and drawings, it does not necessarily mean that the flow must be performed in that order.

### EXPLANATION OF REFERENCES

22: camera
24: vehicle speed sensor
26: yaw rate sensor
29: sensor
30: AEB
32: display device
34: communication device
80: pedestrian
210: first identification unit
220: second identification unit
230: time calculating unit
240: determination unit
250: angular velocity acquisition unit
260: communication control unit
270: report control unit
280: storage unit
2000: computer
2010: host controller
2012: CPU
2014: RAM
2020: I/O controller
2022: communication interface
2024: flash memory
2026: ROM
2040: I/O chip

What is claimed is:

1. A control device comprising:
a first identification unit configured to identify a position of a target located ahead of an advancing direction of a mobile object;
a time calculating unit configured to calculate time taken by the mobile object to reach the position of the target identified by the first identification unit;
a second identification unit configured to identify the position of the target in a direction intersecting the advancing direction from an image captured by an image capturing unit installed in the mobile object;
a determination unit configured to determine whether a difference between a position of the mobile object and the position of the target in the direction intersecting the advancing direction is within a predetermined range when the time calculated by the time calculating unit has become shorter than a predetermined threshold and it is determined that the position of the mobile object in the advancing direction has reached the position identified by the first identification unit; and
a report control unit configured to perform report control when the determination unit determines that the difference between the position of the mobile object and the position of the target in the direction intersecting the advancing direction is within the predetermined range.

2. The control device according to claim 1, wherein:
the report control unit is configured to perform the report control when the determination unit determines that the difference between the position of the mobile object and the position of the target in the direction intersecting the advancing direction is within the predetermined range and the time taken by the mobile object to reach the position of the target identified by the first identification unit is shorter than the predetermined threshold.

3. The control device according to claim 1, wherein:
the time calculating unit is configured to calculate the time taken by the mobile object to reach the position of the target based on a temporal rate of change in a size of a figure of the target extracted from the image captured by the image capturing unit.

4. The control device according to claim 1, further comprising:
an angular velocity acquisition unit configured to acquire angular velocity information of the mobile object from a sensor that is installed in the mobile object and detects a rotational movement of the mobile object,
wherein the second identification unit is configured to calculate the position of the mobile object in the direction intersecting the advancing direction based on angular velocity information of the mobile object and velocity information in the advancing direction of the mobile object.

5. The control device according to claim 1, further comprising:
a communication control unit configured to control reception of a position of a mobile terminal from the mobile terminal located at a position identified by the first identification unit,
wherein the determination unit is configured to correct the predetermined range based on the position of the mobile terminal received from the mobile terminal.

6. The control device according to claim 1, wherein:
the mobile object is a vehicle.

7. The control device according to claim 6, wherein:
the report control unit is configured to control a call to a call center that is available to take a call from an occupant of the vehicle.

8. The control device according to claim 6, wherein:
the report control unit is configured to perform the report control when the vehicle stops.

9. The control device according to claim 6, wherein:
the report control unit is configured to perform the report control even when an airbag installed in the vehicle is not deployed.

10. The control device according to claim 6, wherein:
after an autonomous emergency brake installed in the vehicle begins to operate as well, the first identification unit, the time calculating unit, and the second identification unit are configured to continue to operate, and the determination unit is configured to determine whether the difference between the position of the vehicle and the position of the target in the direction intersecting the advancing direction is within the predetermined range.

11. The control device according to claim 2, wherein:
the time calculating unit is configured to calculate the time taken by the mobile object to reach the position of the target based on a temporal rate of change in a size of a figure of the target extracted from the image captured by the image capturing unit.

12. The control device according to claim 2, further comprising:
an angular velocity acquisition unit configured to acquire angular velocity information of the mobile object from a sensor that is installed in the mobile object and detects a rotational movement of the mobile object,
wherein the second identification unit is configured to calculate the position of the mobile object in the direction intersecting the advancing direction based on angular velocity information of the mobile object and velocity information in the advancing direction of the mobile object.

13. The control device according to claim 2, further comprising:
a communication control unit configured to control reception of a position of a mobile terminal from the mobile terminal located at a position identified by the first identification unit,
wherein the determination unit is configured to correct the predetermined range based on the position of the mobile terminal received from the mobile terminal.

14. The control device according to claim 2, wherein:
the mobile object is a vehicle.

15. The control device according to claim 14, wherein:
the report control unit is configured to control a call to a call center that is available to take a call from an occupant of the vehicle.

16. The control device according to claim 14, wherein:
the report control unit is configured to perform the report control when the vehicle stops.

17. The control device according to claim 14, wherein:
the report control unit is configured to perform the report control even when an airbag installed in the vehicle is not deployed.

18. A mobile object comprising the control device according to claim 1.

19. A report control method comprising:
first identifying a position of a target located ahead of an advancing direction of a mobile object;
calculating time taken by the mobile object to reach the position of the target identified by the first identifying;
second identifying the position of the target in a direction intersecting the advancing direction from an image captured by an image capturing unit installed in the mobile object;
determining whether a difference between a position of the mobile object and the position of the target in the direction intersecting the advancing direction is within a predetermined range when the time calculated by the calculating has become shorter than a predetermined threshold and it is determined that the position of the mobile object in the advancing direction has reached the position identified by the first identifying; and
report controlling when the determining determines that the difference between the position of the mobile object and the position of the target in the direction intersecting the advancing direction is within the predetermined range.

20. A non-transitory computer-readable storage medium having stored thereon a program that causes a computer to function as:
a first identification unit configured to identify a position of a target located ahead of an advancing direction of a mobile object;
a time calculating unit configured to calculate time taken by the mobile object to reach the position of the target identified by the first identification unit;
a second identification unit configured to identify the position of the target in a direction intersecting the advancing direction from an image captured by an image capturing unit installed in the mobile object;
a determination unit configured to determine whether a difference between a position of the mobile object and the position of the target in the direction intersecting the advancing direction is within a predetermined range when the time calculated by the time calculating unit has become shorter than a predetermined threshold and it is determined that the position of the mobile object in the advancing direction has reached the position identified by the first identification unit; and
a report control unit configured to perform report control when the determination unit determines that the difference between the position of the mobile object and the position of the target in the direction intersecting the advancing direction is within the predetermined range.
